(19) United States
(12) Patent Application Publication
(10) Pub. No.: US 2021/0097758 A1
(43) Pub. Date: Apr. 1, 2021

(54) 3D Garment Fitting Method

(71) Applicant: ULSee Inc., Taipei City 104 (TW)

(72) Inventor: Adam Michael Baumberg, Guildford (GB)

(21) Appl. No.: 16/583,363

(22) Filed: Sep. 26, 2019

(51) Int. Cl. G06T 17/00; G06T 15/10

(52) U.S. Cl. CPC G06T 17/00; A47F 8/00; G06T 15/10

(57) ABSTRACT

A 3D garment fitting method is provided. The method includes the following steps: A: 3D-scanning a mannequin to form a first 3D body shape figure file; B: wearing a garment on the mannequin to form a garment mannequin; C: 3D-scanning the garment mannequin to form a body shape and garment figure file; D: removing a part of the body shape and garment figure file including the first 3D body shape figure file to form a first 3D garment figure file; E: 3D-scanning an actual body shape of a user to form a second 3D body shape figure file; F: stretching or cutting the first 3D body shape figure file into the second 3D body shape figure file, and defining a scale of the stretching or the cutting as a 3D deformation; and G: adjusting the first 3D garment figure file according to the 3D deformation to form a second 3D garment figure file.

### FIELD OF THE INVENTION

The present invention relates to a 3D garment fitting method, in particular, to a 3D garment fitting method applying 3D deformation.

### BACKGROUND OF THE INVENTION

With the popularity of e-commerce, online shopping has been favored by people for its convenience, time-saving and money saving. Online shopping has become a living habit for the consumer, which has immersed into people's daily lives.

However, for the purchase of clothes online, consumers may encounter the trouble of not being able to try on clothes and not knowing what they look like when putting the clothes on. Although some garment websites offer the feature of “virtual fitting room”, this feature is based on a simple 2D texture stitching of the user's avatar and website clothes to show the fitting effect, but the real situation in which the clothes are worn by the user cannot be shown. Therefore, when the user tries on the clothes purchased online, he will find that the clothes are not suitable for wearing, which resulted in a very high rate of returned goods and replaced goods.

Thus, how to make the effect presented in the virtual fitting room close to the actual situation in which the user is wearing the clothes is worthy of consideration by those skilled in the art.

### SUMMARY OF THE INVENTION

For above problems, a 3D garment fitting method is provided in the present invention in order to make the effect presented in the virtual fitting room close to the actual situation in which the user is wearing the clothes.

According to an exemplary embodiment, a 3D garment fitting method is provided. The method includes the following steps: A: 3D-scanning a mannequin to form a first 3D body shape figure file; B: wearing a garment on the mannequin to form a garment mannequin; C: 3D-scanning the garment mannequin to form a body shape and garment figure file; D: removing a part of the body shape and garment figure file including the first 3D body shape figure file to form a first 3D garment figure file; E: 3D-scanning an actual body shape of a user to form a second 3D body shape figure file; F: stretching or cutting the first 3D body shape figure file into the second 3D body shape figure file, and defining a scale of the stretching or the cutting as a 3D deformation; and G: adjusting the first 3D garment figure file according to the 3D deformation to form a second 3D garment figure file.

In one embodiment, a step H of combining the second 3D garment figure file with the second 3D body shape figure file to form a user body shape and garment figure file.

In one embodiment, the mannequin further includes a plurality of sensing markers, and the plurality of sensing markers are evenly distributed on the surface of the mannequin.

In one embodiment, a 3D scanner is used to scan the mannequin.

In one embodiment, the 3D scanner is used to scan the garment mannequin.

In one embodiment, the 3D scanner is used to scan the actual body shape of the user.

### BRIEF DESCRIPTION OF THE DRAWINGS

Aspects of the present invention are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a 3D garment fitting method according to the present embodiment.

FIG. 2A illustrates a view showing that a 3D scanner scans a mannequin.

FIG. 2B illustrates a view of a first 3D body shape figure file 51.

FIG. 3 illustrates a view of a garment mannequin 6.

FIG. 4A illustrates a view showing that a 3D scanner 4 scans the garment mannequin 6.

FIG. 4B illustrates a view of a first body shape and garment figure file 61.

FIG. 5 illustrates a view of a first 3D garment figure file 61A.

FIG. 6A illustrates a view showing that a 3D scanner 4 scans a user 8.

FIG. 6B illustrates a view of a first and second 3D body shape figure file 81.

FIG. 7 illustrates a view showing that the first 3D body shape figure file 51 is stretched into the second 3D body shape figure file 81.

FIG. 8A illustrates a view of adjustment of the first 3D garment figure file 61A.

FIG. 8B illustrates a view of the second 3D garment figure file 61B.

FIG. 9 illustrates a view of a user body shape and garment figure file 91.

### DETAILED DESCRIPTION OF PREFERRED EMBODIMENTS

The following invention provides different embodiment, or examples, for implementing different features of the provided subject matter. Specific examples of components and arrangements are described below to simplify the present invention. These are, of course, merely examples and are not intended to be limiting. For example, the formation of a first feature over or on a second feature in the description that follows may include embodiment in which the first and second features are formed in direct contact, and may also include embodiment in which additional features may be formed between the first and second features, such that the first and second features may not be in direct contact. In addition, the present invention may repeat reference numerals and/or letters in the various examples. This repetition is for the purpose of simplicity and clarity and does not in itself dictate a relationship between the various embodiment and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

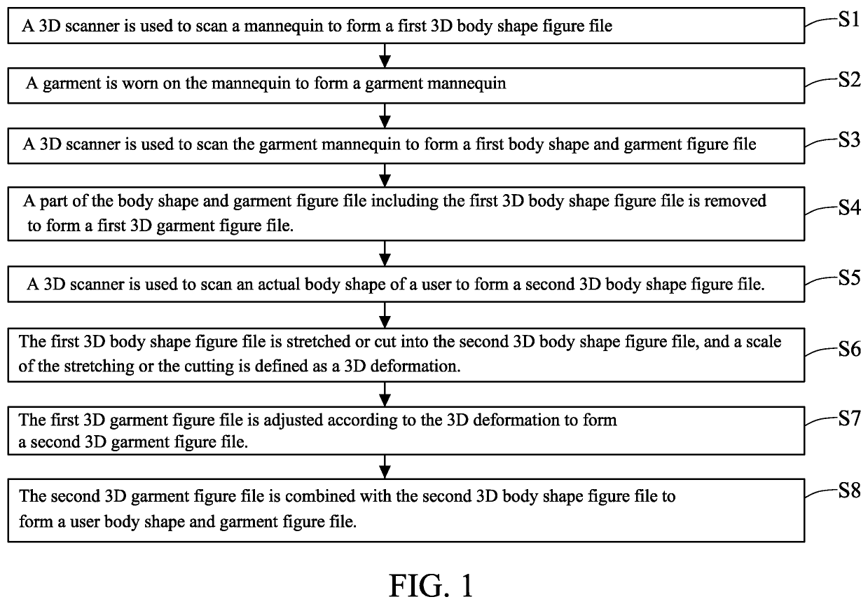

With reference to FIG. 1, FIG. 1 illustrates a 3D garment fitting method according to the present embodiment. The 3D garment fitting method comprises the following steps.

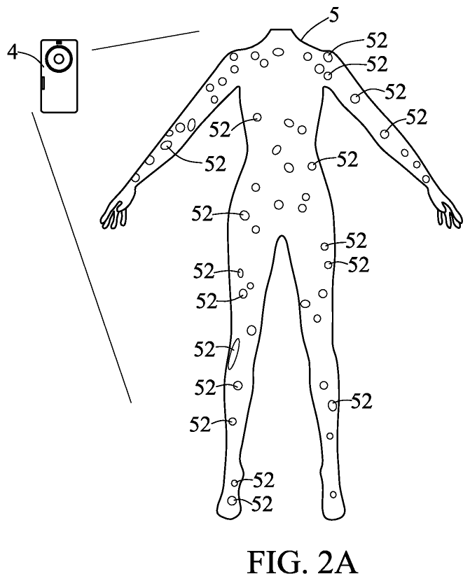

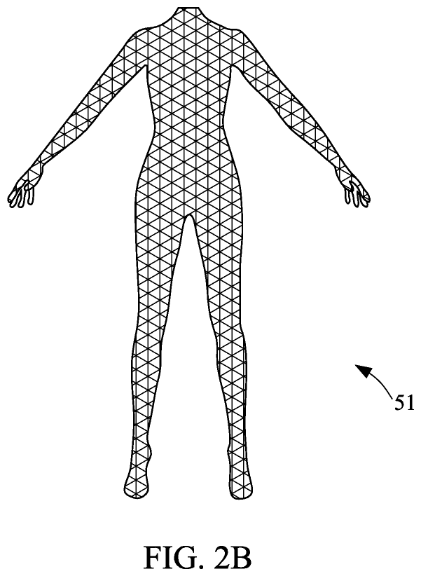

First, with reference to the step S1, FIG. 2A and FIG. 2B (FIG. 2A illustrates a view showing that a 3D scanner scans a mannequin, and FIG. 2 B illustrates a view of a first 3D body shape figure file 51), a 3D scanner 4 is used to scan a mannequin 5 to form a first 3D body shape figure file 51. Among them, the mannequin 5 further includes a plurality of sensing markers 52, and the plurality of sensing markers 52 are evenly distributed on the surface of the mannequin 5. In this way, the 3D scanner 4 is facilitated to scan, and the first 3D body shape figure file 51 is also closer to the true scale.

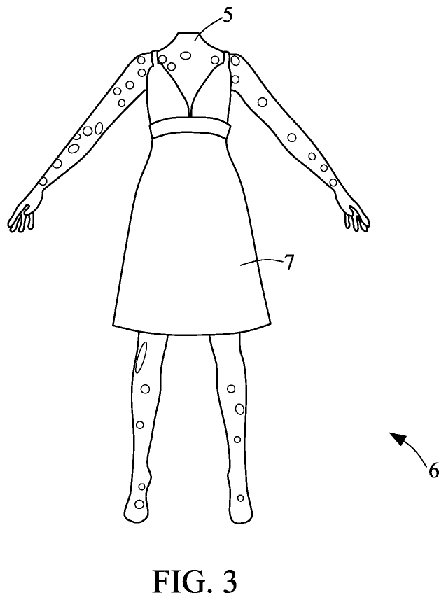

Then, with reference to the step S2 and FIG. 3 (FIG. 3 illustrates a view of a garment mannequin 6), a garment 7 is worn on the mannequin 5 to form a garment mannequin 6. Among them, the garment 7 is the garment to be fitted.

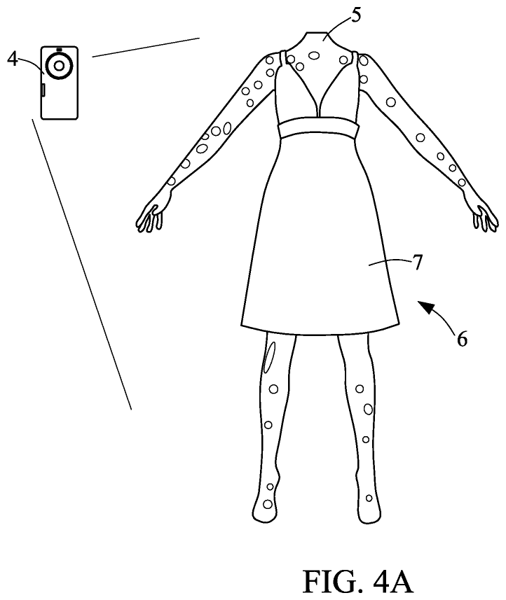

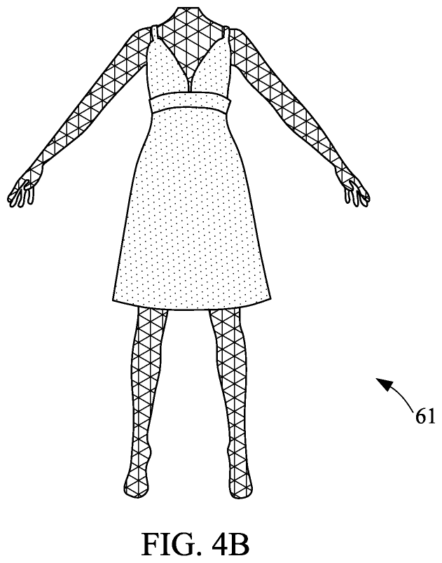

Thereafter, with reference to the step S3, FIG. 4A and FIG. 4B (FIG. 4A illustrates a view showing that a 3D scanner 4 scans the garment mannequin 6, and FIG. 4B illustrates a view of a first body shape and garment figure file 61), a 3D scanner 4 is used to scan the garment mannequin 6 to form a first body shape and garment figure file 61.

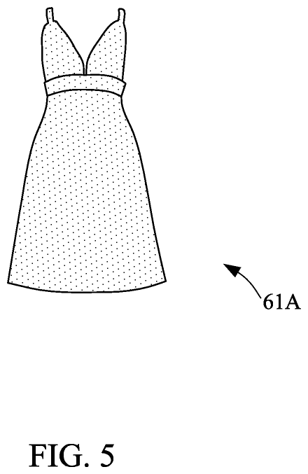

After that, with reference to the step S4 and FIG. 5 (FIG. 5 illustrates a view of a first 3D garment figure file 61A), a part of the body shape and garment figure file including the first 3D body shape figure file 51 is removed to form a first 3D garment figure file 61A. In this way, the first 3D garment figure file 61A is equivalent to a 3D figure file of the garment 7.

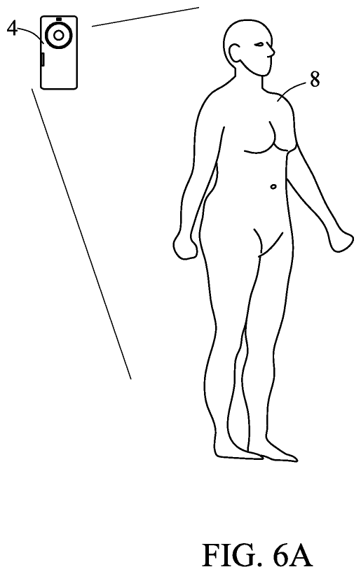

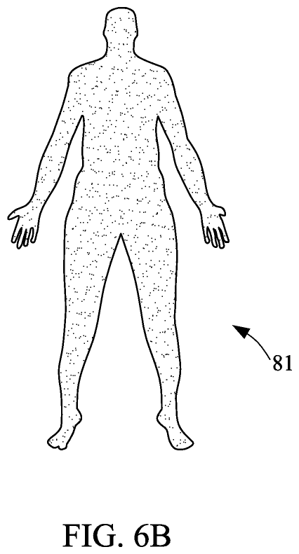

Then, with reference to the step S5, FIG. 6A and FIG. 6B (FIG. 6A illustrates a view showing that a 3D scanner 4 scans a user 8, and FIG. 6B illustrates a view of a first and second 3D body shape figure file 81), a 3D scanner 4 is used to scan an actual body shape of a user 8 to form a second 3D body shape figure file 81. Specifically, the second 3D body shape figure file 81 is the actual body shape of the user 8, and generally the volume of the second 3D body shape figure file 81 is larger than the volume of the first 3D body shape figure file 51 (the present embodiment also uses this case as an example).

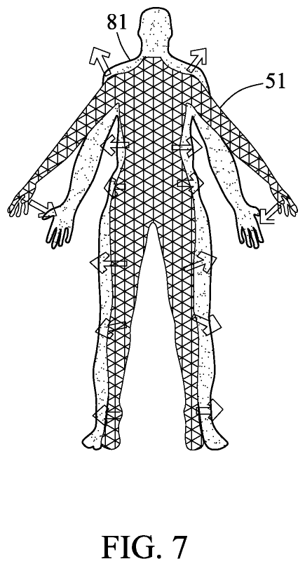

And then, with reference to the step S6 and FIG. 7 (FIG. 7 illustrates a view showing that the first 3D body shape figure file 51 is stretched into the second 3D body shape figure file 81), the first 3D body shape figure file 51 is stretched or cut into the second 3D body shape figure file 81, and a scale of the stretching or the cutting is defined as a 3D deformation. In detail, when the volume of the first 3D body shape figure file 51 is smaller than the volume of the second 3D body shape figure file 81, the first 3D body shape figure file 51 needs to be stretched. In contrast, when the volume of the first 3D body shape figure file 51 is greater than the volume of the second 3D body shape figure file 81, the first 3D body shape figure file 51 needs to be cut to approximate the second 3D body shape figure file 81 and to obtain the 3D deformation.

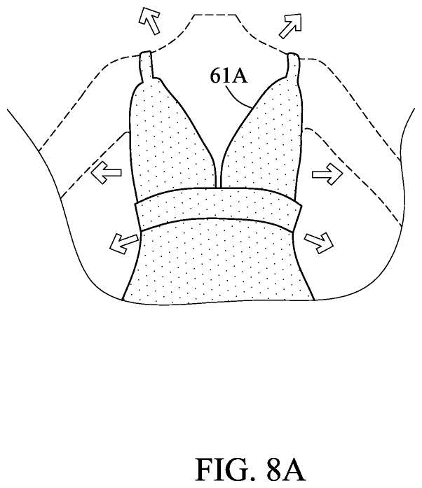

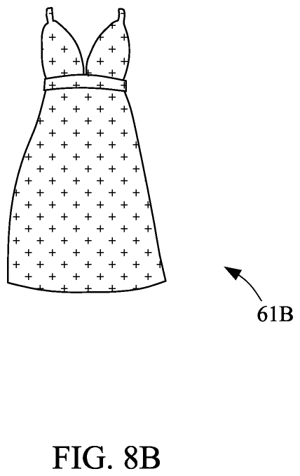

Subsequently, with reference to the step S7, FIG. 8A and FIG. 8B (FIG. 8A illustrates a view of adjustment of the first 3D garment figure file 61A, and FIG. 8B illustrates a view of the second 3D garment figure file 61B), the first 3D garment figure file 61A is adjusted according to the 3D deformation to form a second 3D garment figure file 61B. In the present embodiment, since the volume of the 3D body shape figure file 51 is smaller than the volume of the second 3D body shape figure file 81, the 3D deformation causes the first 3D garment figure file 61A to be stretched to form the second 3D garment figure file 61B.

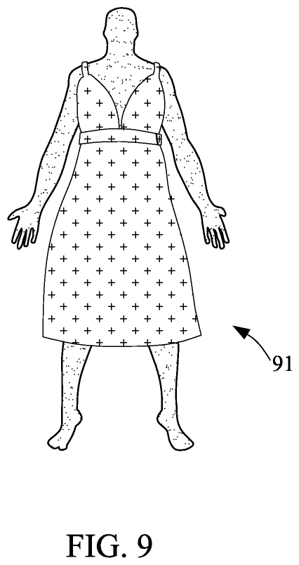

Then, with reference to the step S8 and FIG. 9 (FIG. 9 illustrates a view of a user body shape and garment figure file 91), the second 3D garment figure file 61B is combined with the second 3D body shape figure file 81 to form a user body shape and garment figure file 91. Specifically, the user body shape and garment figure file 91 is a 3D figure file that simulates the user fitting on the garment 7. Therefore, compared with showing fitting effect traditionally by stitching 2D textures, the 3D garment fitting method of the present embodiment may show the actual situation of the user wearing his own garment, so after the user tries on the garment purchased online, the user may not feel too much difference as compared with the virtual fitting effect, so that the rate of subsequent return and replacement may be reduced.

In summary, the 3D garment fitting method of the present embodiment may display the actual situation in which the user himself wears the garment in a virtual manner.

The foregoing outlines features of several embodiments so that those skilled in the art may better understand the aspects of the present invention. Those skilled in the art should appreciate that they may readily use the present invention as a basis for designing or modifying other processes and structures for carrying out the same purposes and/or achieving the same advantages of the embodiments introduced herein. Those skilled in the art should also realize that such equivalent constructions do not depart from the spirit and scope of the present invention, and that they may make various changes, substitutions, and alterations herein without departing from the spirit and scope of the present invention.

What is claimed is:

1. A 3D garment fitting method, characterized by comprising steps of:
A: 3D-scanning a mannequin to form a first 3D body shape figure file;
B: wearing a garment on the mannequin to form a garment mannequin;
C: 3D-scanning the garment mannequin to form a body shape and garment figure file;
D: removing a part of the body shape and garment figure file including the first 3D body shape figure file to form a first 3D garment figure file;
E: 3D-scanning an actual body shape of a user to form a second 3D body shape figure file;
F: stretching or cutting the first 3D body shape figure file into the second 3D body shape figure file, and defining a scale of the stretching or the cutting as a 3D deformation; and
G: adjusting the first 3D garment figure file according to the 3D deformation to form a second 3D garment figure file.

2. The 3D garment fitting method according to claim 1, characterized by further comprising a step H of combining the second 3D garment figure file with the second 3D body shape figure file to form a user body shape and garment figure file.

3. The 3D garment fitting method according to claim 1, characterized in that in the step A, the mannequin further includes a plurality of sensing markers, and the plurality of sensing markers are evenly distributed on the surface of the mannequin.

4. The 3D garment fitting method according to claim 1, characterized in that in the step A, a 3D scanner is used to scan the mannequin.

5. The 3D garment fitting method according to claim 3, characterized in that in the step C, the 3D scanner is used to scan the garment mannequin.

6. The 3D garment fitting method according to claim 3, characterized in that in the step E, the 3D scanner is used to scan the actual body shape of the user.
